(19) United States
(12) Patent Application Publication
(10) Pub. No.: US 2025/0077881 A1
(43) Pub. Date: Mar. 6, 2025

(54) CONTINUOUS REINFORCEMENT LEARNING FOR SCALING QUEUE-BASED SERVICES

(71) Applicant: Adobe Inc., San Jose, CA (US)

(72) Inventors: Michael Gebhard FRIEDRICH, San Francisco, CA (US); Li ZHANG, Danville, CA (US)

(21) Appl. No.: 18/241,137

(22) Filed: Aug. 31, 2023

(51) Int. Cl. G06N 3/092; G06N 3/084

(52) U.S. Cl. CPC G06N 3/092; G06N 3/084

(57) ABSTRACT

In various examples, a machine learning model determines scaling operations for a computing environment based on a state of the computing environment. For example, a first machine learning model determines a scaling operation based on a first state of a computing environment executing a service, and a second machine learning model determines an estimated value associated with a second state of the computing environment after the scaling operation is performed. A set of parameters of the first machine learning model are updated to maximize an advantage value determined based on the estimated value and a reward value.

### BACKGROUND

Various types of artificial intelligence (AI) models can be trained using various training techniques. For example, reinforcement learning such as deep Q-learning techniques can be used to train deep neural networks (DNNs) or other networks. In one example, reinforcement learning used to train a model to determine scaling operations for computing resources of a service. In addition, these trained models, for example, are used to ensure that the service has sufficient computing resources to process requests without excess computing resources remaining idle for extended periods.

### SUMMARY

Embodiments described herein are directed to a machine learning model that utilizes continuous reinforcement learning to perform scaling operations for queue-based services. Advantageously, in various embodiments, the systems and methods described are directed towards training a machine learning model to making scaling decisions using an accumulative reward value. In such embodiments, the accumulative reward value is used as a reinforcement signal to generate a policy gradient to update the parameters of the machine learning model. In particular, a proximal policy optimization (PPO) machine learning model determines scaling operations that cause modification to the instances supporting or otherwise providing computing resources for a queue-based service. For example, the PPO machine learning model obtains state information (e.g., metrics or other time series data) associated with a computing environment (a set of computing instances executing a queue-based service) and determines scaling operations. In addition, the PPO machine learning model is capable of determining or otherwise selecting scaling operations from a continuous solution space. In other words, the solution space from which the PPO machine learning model is capable of selecting from is infinite and, therefore, the PPO machine learning model can determine any possible scaling operation. For example, the PPO machine learning model can scale up or down any number of instances, modify the configuration of the instances, modify the configuration of a network connected to the instances, or perform any other operation associated with instances supporting a queue-based service.

Furthermore, the PPO machine learning model is trained using a critic machine learning model that generates a value (e.g., a value representing the expectation of a Q-value, which is then used to estimate an advantage value that represents an improvement of the new policy over a previous policy) based on state information associated with the computing environment after the scaling operation has been performed. For example, the value is a weighted accumulated reward value for a set of time steps (e.g., intervals time during training). In this manner, training the PPO machine learning model can take into account long term effects of the scaling operation as a result of continuously (e.g., for a plurality of time steps) calculating the reward value. Furthermore, an advantage value is determined based on the Q-value and a generalization of the average of the Q-value (e.g., using Monte Carlo sampling). For example, the advantage value is used to generate a policy gradient, which is used to update parameters of the PPO machine learning model through backpropagation.

### BRIEF DESCRIPTION OF THE DRAWINGS

The present technology is described in detail below with reference to the attached drawing figures, wherein:

FIG. 1 depicts an environment in which one or more embodiments of the present disclosure can be practiced.

FIG. 2 depicts an environment in which a scaling tool generates scaling operations for a computing environment, in accordance with at least one embodiment.

FIG. 3 depicts an environment in which a queue-based service is simulated for training a machine learning model of a scaling tool, in accordance with at least one embodiment.

FIG. 4 depicts an example process flow for training a scaling model of a scaling tool, in accordance with at least one embodiment.

FIG. 5 depicts an example process flow for performing inferencing using a scaling model of a scaling tool, in accordance with at least one embodiment.

FIG. 6 is a block diagram of an exemplary computing environment suitable for use in implementations of the present disclosure.

### DETAILED DESCRIPTION

Various cloud computing services rely on a queue to track and process requests. In many cases, these queue-based services utilize computing resources (e.g., processors, virtual machines, storage devices, networking devices, etc.) provided by a computing resource service provider to execute an application and/or provide cloud based services. These computing resources service providers enable resource scaling in order to handle unexpected load scenarios. For example, a number of computing instances processing requests from the queue can be increased in response to an influx of requests. However, load for queue-based services can fluctuate rapidly and is difficult to predict, making it difficult to maintain the appropriate amount of computing resources to service requests while minimizing costs.

As a result, determining an appropriate scaling operation at any given time in order to process incoming requests while reducing an amount of unnecessary computing resources can be difficult and inaccurate. In addition, other solutions are unable to support a wide variety of scaling operations that can handle the unexpected nature of queue-based cloud services. For example, one manner of performing scaling operations is to set thresholds and/or watermarks to determine when to scale up or down. These simple heuristics waste a significant amount of resources, increase cost, and perform poorly during unexpected load scenarios. Furthermore, these approaches only scale one type of computing resources (e.g., add or remove computing instances) and can only select scaling operations from a finite set (e.g., add one computing instance, remove one computing instance, or do nothing). As a result, this is a fixed strategy that cannot adapt dynamically nor consider other tunable factors of the computing service (e.g., processor utilization, memory utilization, queue length, etc.).

Other conventional approaches that use reinforced learning solutions are skewed to the policy generated by the human trainers. In one example, these reinforced learning approaches can only operate in a small discrete action space (e.g., scaling operations). Furthermore, these solutions are instantaneous and do not predict the future, so the delay of performing scaling operations (e.g., the time required for a computing instance to finish processing requests before it can be terminated) causes the model to perform poorly.

Accordingly, embodiments described herein generally relate to a machine learning model that utilizes continuous reinforcement learning to improve the identification and/or performance of scaling operations for queue-based services. In accordance with some aspects, the systems and methods described are directed to training a machine learning model to make or otherwise determine scaling decisions and using an accumulative reward value as a reinforcement signal to generate a policy gradient to update the parameters of the machine learning model (e.g., through backpropagation). For example, a proximal policy optimization (PPO) machine learning model identifies or determines scaling operations that cause modification to a set of computing instances supporting or otherwise providing computing resources for a queue-based service. In addition, in some embodiments, the PPO machine learning model is capable of determining or otherwise selecting scaling operations from a continuous solution space. In one example, the solution space from which the PPO machine learning model is capable of selecting from is infinite and, therefore, the PPO machine learning model can perform any possible scaling operation. In various embodiments, the PPO machine learning model can scale up or down by any number of instances (e.g., scale up zero to n computing instances), modify the configuration of the computing instances (e.g., add memory to a computing instance), modify the configuration of a network connected to the computing instances, or perform any other operation associated with computing instances supporting a queue-based service.

In various embodiments, during training of the PPO machine learning model, the PPO machine learning model begins by selecting scaling operations randomly and/or pseudorandomly from the solution space, and a reward value is determined based on the state of the environment after the scaling operation, which is used to update the parameters of the PPO machine learning model. For example, at any given time step (e.g., an interval of time at which the performance of the PPO machine learning model is evaluated), a reward value is calculated or otherwise updated. In various embodiments, the PPO machine learning model includes two models: an actor and a critic. In such embodiments, the actor determines the scaling operations based on the policy(s), and the critic determines the reward value (e.g., the value for being in a particular state). For example, the critic estimates the accumulated reward value from a particular time step to the end of a training episode (e.g., 100,000 time steps, where a time step is one minute) using a generalized advantage estimation. In other examples, the accumulated reward value is calculated directly. In another example, the critic estimates the accumulated reward value from a particular number of scaling operations (e.g., 10,000 actions), then policy gradients are generated and used to update the model.

In various embodiments, an advantage value is determined and used to update the policy gradient, which is used to update the parameters of the actor using backpropagation. In one example, as mentioned above, the actor generates the action, and the critic model generates a value that represents how well the model performed (e.g., how well the model mimics the reward value). Continuing with this example, this value can be determined based on a Monte Carlo sampling of the reward value for a specific set of time steps and/or an episode. In various embodiments, the value is a generalization of the reward value for a plurality of episodes. Furthermore, in such embodiments, the advantage value is used as a signal to train or otherwise update the actor, where the advantage value is determined based on the reward value for a specific time step minus a generalized and/or average reward value over multiple time steps.

During inferencing, in some embodiments, the actor of the PPO machine learning model generates scaling decisions based on the state of the computing environment and the critic is not used. For example, the PPO machine learning model takes as an input metrics associated with the computing environment such as queue length, number of computing instances, latency, processor utilization, memory utilization, or other data associated with the computing environment and determines the scaling operations. In other embodiments, the critic is used during inferencing to continue to update the model parameters associated with the actor. In one example, the actor generates scaling decisions based on a state of a production computing environment, and the critic determines the reward value, which is used to update the model parameters associated with an actor of the PPO machine learning model executing on a test computing environment such that the queue-based service is not negatively affected by updates to the model parameters.

Aspects of the technology provide a number of improvements over existing technologies. For example, existing solutions are unable to handle unpredictable demand and appropriately allocate resources to balance operational cost and performance. Furthermore, in some instances, scaling systems use heuristics and/or policies based on experience and/or previous history; however, these systems perform poorly during periods of unexpected load. For example, existing technologies use high and low watermarks to determine whether to scale up or scale down. As a result, such technologies are not able to consider other factors in the complex queue-based service environment. As such, the PPO machine learning model provides an improvement over existing technologies by considering additional aspects of the complex queue-based service environment allowing for additional scaling operations. Furthermore, the PPO machine learning model generates continuous scaling operations which can handle large changes in the number of requests, thereby providing better performance for queue-based services. As a result, the PPO machine learning model reduces the use of computing resources by efficiently scaling to adjust to load without maintain idle computing resources. In addition, the PPO machine learning model reduces and/or prevents service down time by ensure that the queue-based service has sufficient computing resources to process requests.

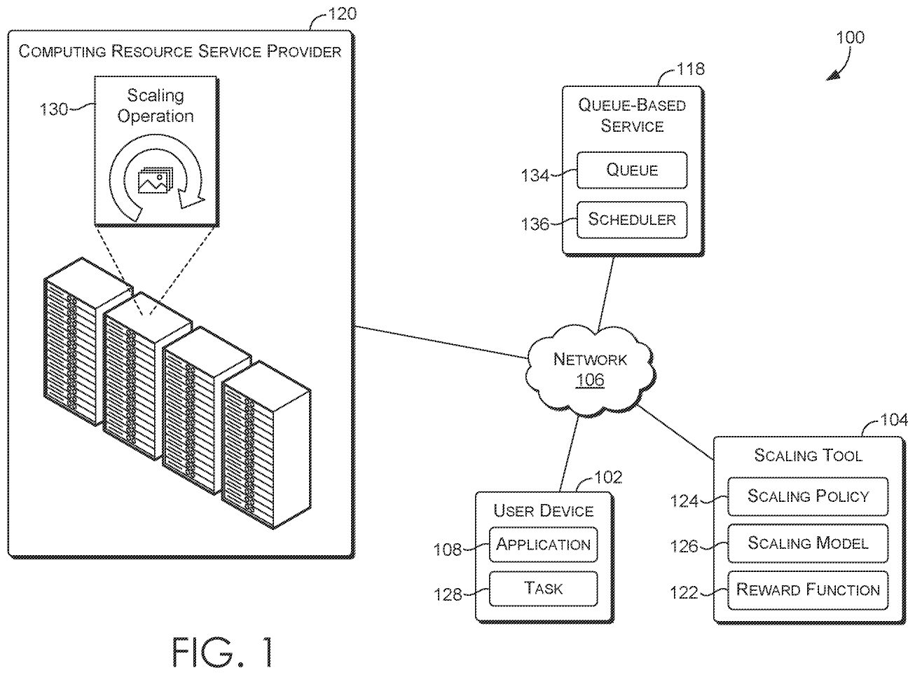

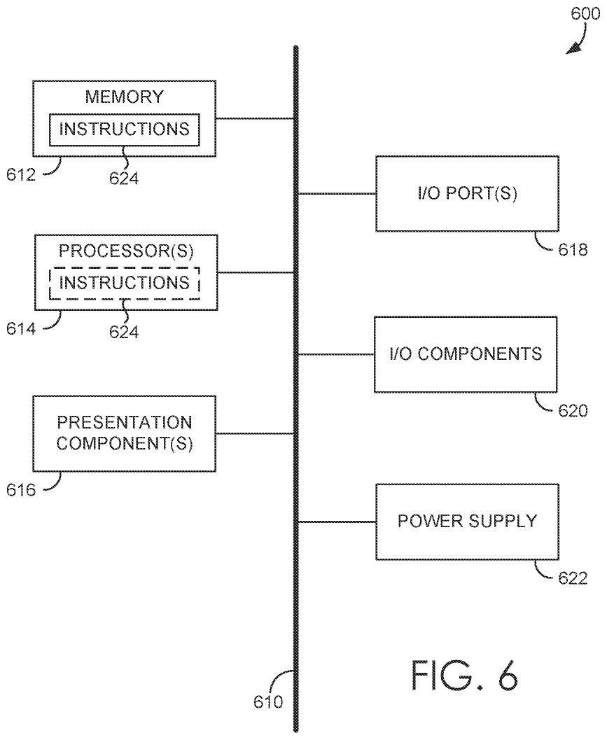

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 6.

It should be understood that operating environment 100 shown in FIG. 1 is an example of one suitable operating environment. Among other components not shown, operating environment 100 includes a user device 102, scaling tool 104, a queue-based service, a computing resource service provider 120, and a network 106. Each of the components shown in FIG. 1 can be implemented via any type of computing device, such as one or more computing devices 600 described in connection with FIG. 6, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the scaling tool 104 and queue-based service 118 includes multiple server computer systems cooperating in a distributed environment to perform the operations described in the present disclosure. In addition, in various embodiments, the computing resource service provider 120 can provide computing resources (e.g., servers, computing instances, and networking components) to any number of devices, servers, and other components within operating environment 100. For example, the queue-based service 118 can be implemented using computing instances (e.g., virtual machine, containers, or other computing resources) provided by the computing resource service provider 120.

User device 102 can be any type of computing device capable of being operated by an entity (e.g., individual or organization) and provides data to the queue-based service 118 (e.g., a server operating as a frontend for the data store). The user device 102, in various embodiments, has access to or otherwise generates a task 128 for processing by the queue-based service 118. For example, the application 108 can include an editing application that generates the task 128 to edit a data object (e.g., image, document, source code, executable, etc.) stored by the queue-based service 118.

In some implementations, user device 102 is the type of computing device described in connection with FIG. 6. By way of example and not limitation, the user device 102 can be embodied as a personal computer (PC), a laptop computer, a mobile device, a smartphone, a tablet computer, a smart watch, a wearable computer, a personal digital assistant (PDA), a music player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the queue-based service 118. For example, the application 108 allows the user device 102 to submit the task 128 to the queue-based service 118 for processing. In various embodiments, the queue-based service 118 includes any service that is capable of queueing processing requests in a queue 134. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and queue-based service 118. In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

For cloud-based implementations, for example, the application 108 is utilized to interface with the functionality implemented by the queue-based service 118. In some embodiments, the components, or portions thereof, of the queue-based service 118 are implemented on the user device 102 or other systems or devices. Thus, it should be appreciated that the queue-based service 118, in some embodiments, is provided via multiple devices arranged in a distributed environment that collectively provide the functionality described herein. Additionally, other components not shown can also be included within the distributed environment.

As illustrated in FIG. 1, scaling tool 104 includes a scaling policy 124, a scaling model 126, and a reward function 122. In an embodiment, the scaling policy 124 indicates a set of scaling operations 130 that, when performed by the computing resource service provider 120 and/or queue-based service 118, cause an amount of computing resources available to the queue-based service 118 to be modified. For example, the scaling policy 124 can include a scale up operation that increases a number of computing instances, provided by the computing resource service provider 120, available to the queue-based service 118.

The scaling model 126, in various embodiments, includes one or more machine learning models that obtains an input from the computing resource service provider 120 and/or queue-based service 118 and determines a scaling operation 130 to be applied or otherwise performed on the queue-based service 118. In one embodiment, the reward function 122 is used to generate a signal (e.g., a reward value) that is used to train the scaling model 126. For example, as described in greater detail below, an accumulative reward value is used as a reinforcement signal to generate a policy gradient to update the parameters of the scaling model 126.

In various embodiments, the scaling tool has access to compute capacity and usage metrics from the computing resource service provider 120 to determine the scaling operation 130. The scaling operation 130, for example, causes computing resource service provider 120 to increase or decrease a number of compute instances that are allocated to process computing tasks, such as the task 128 generated by user device 102 and/or application 108. In other embodiments, the scaling operation 130 causes the computing resource service provider 120 to modify computing resources available to the queue-based service 118. For example, the scaling operation 130 can include any modification to computing resources of the queue-based service 118, such as compute capacity, memory capacity, networking capacity, distribution of computing resources within geographical regions, or any other attribute of computing resources allocated to the queue-based service 118. In a specific example, the scaling operation 130 could indicate an increase to an amount of processing capacity available to a computing instance of the queue-based service 118. In this manner, in various embodiments, unneeded computing resources are not allocated to the queue-based service 118 (e.g., during an interval with fewer tasks) while sufficient computing resources are deployed and/or allocated in the event of a surge in demand (e.g., an increased number of tasks during an interval).

As described above, the user device 102 can perform any computing functions in accordance with various embodiments. Examples of computing functions include image processing, document processing, and web browsing. In the process of performing these functions, in an embodiment, user device 102 sends a request for the task 128 to be performed to computing resource service provider 120 (e.g., a front-end or other server computer system provided by the computing resource service provider 120). In such embodiments, the computing resource service provider 120 inserts a request and/or message (e.g., data including or otherwise indicating the task 128) into the queue 134. For example, the queue 134 includes a set of tasks of which the task 128 is a member. In an embodiment, the task 128 includes data to be processed by the queue-based service 118.

In an embodiment, a scheduler 136 allocates tasks from queue 134 to one or more of the compute instances (not shown in FIG. 1 for simplicity) implementing the queue-based service 118. In one example, the scheduler 136 can use different approaches to determine an order in which a particular task is processed, e.g., round robin, first in first out, priority based, etc. In various embodiments, the compute instances can be virtual (e.g., a virtual machine, container, or a maximum proportion of resources such as processor cycles), logical (e.g., a logical core of a processor), or physical (e.g., a processor core or a computing system).

In some embodiments, scaling tool 104 can be integrated with the computing resource service provider 120. In addition, in some embodiments, the user device 102 and/or application 108 transmits or otherwise provides the task 128 directly to the queue-based service 118. In yet other embodiments, the scaling tool 104 provides the task 128 to the computing resource service provider 120 and/or queue-based service 118.

In an embodiment, the scaling tool 104 provides the scaling operation 130 to computing resource service provider 120. For example, the computing resource service provider 120 uses the scaling operation 130 to modify the number of compute instances allocated to the queue-based service 118 to process tasks from the queue 134. In an embodiment, the scaling tool 104 obtains inputs to the scaling model 126 (e.g., metrics) from the computing resource service provider 120 and/or queue-based service 118.

In one example, the metrics indicate various attributes of the computing environment associated with the queue-based service 118, such as an amount of available compute capacity (e.g., a maximum number of compute instances in a warming pool that could be allocated), a load (e.g., utilization of computing resources), a queue length and/or size, a number of computing instances allocated (e.g., computing instances currently processing requests for the queue-based service 118), a number of computing instances to be terminated, network information, attributes of computing instances (e.g., processing capacity or memory capacity of computing instances either allocated to the queue-based service 118 or available for allocation from the computing resource service provider 120), a number of tasks in queue 134, a number of tasks that are currently being processed, or a rate at which new tasks are obtained. In an embodiment, the load is determined based on an average of the compute capacity being used by the allocated compute instances. For example, if a first compute instance allocated is used at forty percent and a second compute instance is used at sixty percent, then the load relative to the total compute capacity is fifty percent.

The scaling model 126, in various embodiments, includes any suitable machine-learning model that can receive metrics as inputs and determine a corresponding scaling operation 130. Furthermore, in some embodiments, the scaling model 126 uses the reward function as a signal to update the parameters of the scaling model 126. Examples of suitable machine learning models include models that can be used with reinforcement learning such as Proximal Policy Optimization (PPO), Deep Q Learning (DQN), Trust Region Policy Optimization (TRPO), and Deep Deterministic Policy Gradient (DDPG) algorithms.

The scaling model 126 is trained, in various embodiments, using a learning process during which one or more parameters of the scaling model 126 are modified in accordance with feedback from the reward function 122. In an embodiment, the scaling model 126 is a PPO model including an actor model to generate the scaling operation 130 and a critic model to generate the signal to update the parameters of the actor based on the reward function 122. In such an embodiment, both the actor model and the critic model obtain feedback (e.g., metrics) from the computing environment. For example, the critic model obtains metrics from the computing environment of the queue-based service 118 after the scaling operation 130 is performed to determine or otherwise calculate a reward value associated with the current state of the queue-based service 118 (e.g., the state of the environment as a result of the scaling operation 130).

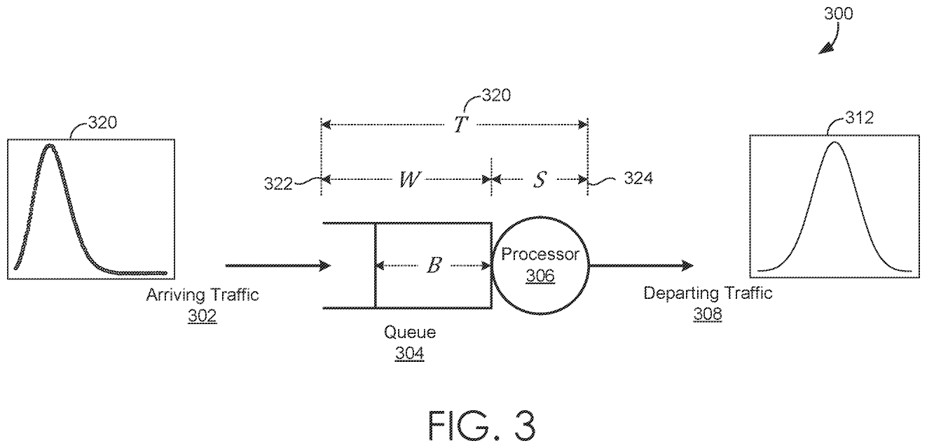

In various embodiments, during training of the scaling model 126, the computing environment and/or queue-based service 118 is simulated. For example, the queue-based service 118 is simulated as described in detail below in connection with FIG. 3. In addition, in various embodiments, the solution space available to the scaling model 126 (e.g., the scaling operations 130 from which the scaling model 126 can select) is infinite. For example, the scaling model 126 can, based on metrics associated with the queue-based service 118, determine to scale-up or scale-down any number of instances. In other embodiments, a penalty or other value is applied to various scaling operations 130 to limit the number of solutions from which the scaling model 126 can select. During an initial training phase, in an embodiment, the scaling model 126 selects scaling operations 130 from the solution space at random.

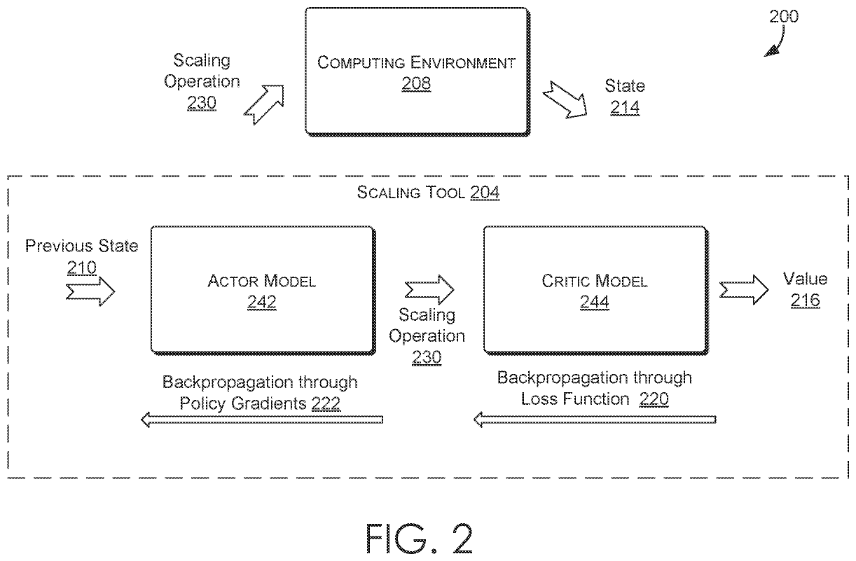

FIG. 2 depicts an environment 200 in which a scaling tool 204 determines scaling operations 230 for a computing environment 208, in accordance with at least one embodiment. In various embodiments, the scaling tool 204 includes an actor model 242 and a critic model 244. For example, as described above in connection with FIG. 1, the scaling tool 204 implements a Proximal Policy Optimization (PPO) model used with reinforcement learning where the actor model 242 generates the scaling operation based on a previous state 210 of the computing environment 208 (e.g., metrics obtained from the computing environment 208), and the critic model 244 generates a value 216 based on the scaling operation 230 and a state of the computing environment after the scaling operations has been performed. In various embodiments, during training, the actor model is updated using backpropagation through policy gradients 222, and the critic model is updated using backpropagation through a loss function 220.

In various embodiments, the actor model 242 determines the scaling operations 230, as described above in connection with FIG. 1. For example, based on the previous state 210, the actor model 242 determines a scaling operation 230 to increase the amount of computing instances within the computing environment 208. In an embodiment, the critic model 244 generates the value 216 V, which represents and/or indicates the performance of the actor model 232. In various embodiments, a Q value is also determined, as defined below, and the value 216 V and the Q value are then used to calculate an advantage value A. In such embodiments, the advantage value A is used to update the parameters of the actor model 242.

In an embodiment, the value 216 V is a Monte Carlo sampling of the Q value, where the Q value is defined for a specific episode and/or time step during training. For example, the value 216 V is a generalization of the Q value for a plurality of episodes and/or time step during training. In various embodiments, the Q value represents the reward for a specific time step given by the following equation:

$${Q}_{DQN}^{π} ( s , a ) \approx r = γ {max}_{{a}^{′}} {Q}^{π} ( {s}^{′} , {a}^{′} ) ,$$

where γ represents a weight value to discount for longer intervals of time (e.g., reduces the influence on the reward values of scaling operation performed previously), s represents the state 214 of the computing environment 208, a represents the scaling operation 230, r represents the reward value, and π represents the current policy. In one example, the reward formula is defined as a number of successful transactions (e.g., successfully processed tasks from the queue) multiplied by a transaction reward (e.g., a value). In this example, the result (e.g., number of successful transactions multiplied by the transaction reward) can be subtracted from the cost of executing a computing instance multiplied by the number of computing instances within the computing environment 208 and a servicedown penalty (e.g., if a task is being discarded as a result of number of tasks in the queue being above a threshold the queue-based service is considered as “down” or otherwise unavailable to process requests). Finally, in this example, the result is added to a reward for not generating a scaling operation minus a queue size penalty. In various embodiments, other formulas for the reward value r can be used.

In various embodiments, the value 216 V represents how the actor model 242 mimicked or otherwise satisfied the reward value (e.g., the Q value). In an embodiment, the advantage value A is defined by the following equation:

$${A}^{π} ( {s}_{t} , {a}_{t} ) = {Q}^{π} ( {s}_{t} , {a}_{t} ) - {V}^{π} ( {s}_{t} ) ,$$

where V^{π}(sₜ) is the state value function of a Markov Decision Process (MDP). For example, the value 216 V represents the expected return starting from state sₜ at time step t following policy π. Returning to the equation above, in an embodiment, Q^{π}(sₜ, aₜ) is the state-action value function, also known as the quality function which represents the expected return starting from state s, taking action a, then following policy π. For example, Q^{π}(sₜ, aₜ) can be defined using the equation for Q_{DQN}^{π} (s, a), as described above.

In various embodiments, the advantage value A^{π}(sₜ, aₜ) is then used to update the model parameters of the actor model 242. For example, using backpropagation through policy gradients 222 as defined by the following equation:

$${∇}_{θ} J ( {π}_{θ} ) = {𝔼}_{t} [ {A}_{t}^{π} {∇}_{θ} log {π}_{θ} ( {a}_{t} \vert {s}_{t} ) ] ,$$

where J is the objective function, A is the advantage value, a is the scaling operation 230, s is the state 214, t is the time step/episode, and π is the policy. In various embodiments, the parameters of the critic model 244 can be updated using backpropagation through a loss function 220. In one example, the mean squared error loss function between the value 216 V and Q is used to update the parameters of the critic model 244.

FIG. 3 depicts an environment 300 in which a queue-based service is simulated for training a machine learning model of a scaling tool, in accordance with at least one embodiment. In various embodiments, arriving traffic 302 includes requests and/or tasks that are placed into a queue 304 for processing by a processor 306 of the queue-based service before being transmitted as departing traffic 308. For example, the arriving traffic is represented by a graph 320 indicating a number of requests received over an interval of time. In various embodiments, the arriving traffic 302 includes the task 128, as described above in connection with FIG. 1. In various embodiments, the departing traffic is represented by a graph 312 indicating a number of processed requests over an interval of time.

In various embodiments, the value T 320 represents a total time a task is with the queue-based services, including the value W 322 representing an amount of time the task is in the queue 304 and the value S 324 representing an amount of time the task is being processed by the processor 306. In one example, the value T 320, including the value W 322 and the value S 324, are used to simulate the queue-based service. For example, the computing environment 208 is simulated using the environment 300.

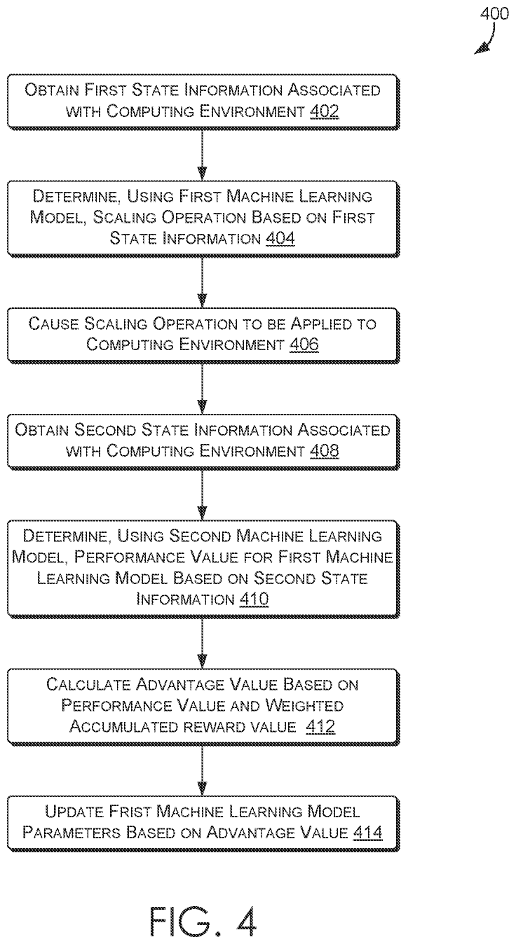

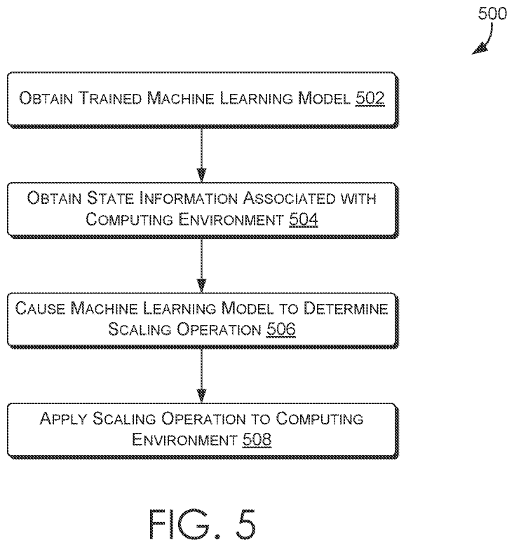

Turning to FIGS. 4 and 5, the method 400 and the method 500 described below can be performed, for instance, by the scaling tool 104 of FIG. 1. Each block of the methods 400 and 500 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

With initial reference to FIG. 4, FIG. 4 is a flow diagram showing a method 400 for training a scaling model of a scaling tool in accordance with at least one embodiment. As shown at block 402, the system implementing the method 400 obtains first state information associated with a computing environment. As described above in connection with FIG. 1, in various embodiments, a queue-based service can be implemented using a computing environment including a number of computing resources, such as computing instances. The state information, in various embodiments, includes metrics or other attributes of the computing environment, such as a number of computing instances, types of computing instances, utilization, computing capacity, or other metrics obtained from the computing environment.

At block 404, the system implementing the method 400 determines, using a first machine learning model, a scaling operation based on the first state information. For example, an actor model of the scaling tool determines a scaling operation based on metrics obtained from the computing environment. As described above, the scaling operation may include any number of operations including determining not to perform a scaling operation. In various embodiments, the actor model maintains two variables, one for scale-up operations and one for scale-down operations as these operations take different amounts of time to complete. At block 406, the system implementing the method 400 causes the scaling operation to be applied to the computing environment. For example, the system implementing the method 400 causes a computing resource service provider to add or remove computing instances from the computing environment.

At block 408, the system implementing the method 400 obtains second state information associated with the computing environment. For example, the second state information include state information after the scaling operation has been performed. At block 410, the system implementing the method 400 determines, using a second machine learning model, a performance value associated with the first machine learning model based on the second state information. For example, a critic model generates a value V representing the performance of the actor model in determining the scaling operation. In such an example, the value V is determined by performing a Monte Carlo sampling of the reward value.

At block 412, the system implementing the method 400 calculates an advantage value based on the performance value and a weighted accumulated reward value. For example, the advantage value A is calculated by subtracting the V value (e.g., the performance value) from the Q value (e.g., weighted accumulated reward value). At block 414, the system implementing the method 400 updates the first machine learning model parameters based on the advantage value. For example, a policy gradient is generated based on the advantage value, and the policy gradient is used to update the parameters of the actor model using backpropagation.

FIG. 5 depicts an example method 500 for performing inferencing using a scaling model of a scaling tool, in accordance with at least one embodiment. As shown at block 502, the system implementing the method 500 obtains a trained machine learning model. As described above in connection with FIG. 2, in various embodiments, a proximal policy optimization (PPO) machine learning model including an actor model and a critic model is trained to determine scaling operations. In various embodiments, the trained machine learning model includes only the actor model.

At block 504, the system implementing the method 500 obtains state information associated with the computing environment. As described above in connection with FIG. 1, in various embodiments, a queue-based service can be implemented using a computing environment including a number of computing resources, such as computing instances. The state information, in various embodiments, includes metrics or other attributes of the computing environment, such as a number of computing instances, types of computing instances, utilization, computing capacity, or other metrics obtained from the computing environment.

At block 506, the system implementing the method 500 causes the machine learning model to determine a scaling operation. For example, the system implementing the method 500 provides to the machine learning model the state information and obtains a scaling operation. At block 508, the system implementing the method 500 applies the scaling operation to the computing environment. For example, the system implementing the method 500 transmits a request to a computing resource service provider to perform the scaling operation on the computing environment.

Having described embodiments of the present invention, FIG. 6 provides an example of a computing device in which embodiments of the present invention may be employed. Computing device 600 includes bus 610 that directly or indirectly couples the following devices: memory 612, one or more processors 614, one or more presentation components 616, input/output (I/O) ports 618, input/output components 620, and illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 6 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. As depicted, memory 612 includes instructions 624. Instructions 624, when executed by processor(s) 614 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 600 includes one or more processors that read data from various entities such as memory 612 or U/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 600. Computing device 600 may be equipped with depth cameras, such as stereoscopic camera systems, infrared camera systems, RGB camera systems, and combinations of these, for gesture detection and recognition. Additionally, computing device 600 may be equipped with accelerometers or gyroscopes that enable detection of motion. The output of the accelerometers or gyroscopes may be provided to the display of computing device 600 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
providing an input to a first machine learning model, the input including a first set of metrics obtained from a computing environment supporting a queue-based service;
determining, using the first machine learning model, a scaling operation based on the input;
determining, using a second machine learning model, a first value indicating a performance of the first machine learning model based on the scaling operation and a second set of metrics obtained from the computing environment;
determining an advantage value based on the first value and a second value representing a weighted accumulated reward value for a set of time steps;
updating a set of parameters of the first machine learning model by at least performing backpropagation through a policy gradient using the advantage value; and
causing the scaling operation to be performed on the computing environment supporting the queue-based service.

2. The method of claim 1, wherein the first machine learning model is an actor network trained to generate scaling operations and the second machine learning model is a critic network trained to generate performance information associated with the first machine learning model based on a state of the computing environment after the scaling operation, where the state of the computing environment is indicated by the second set of metrics.

3. The method of claim 2, wherein the first machine learning model and the second machine learning model further comprise a proximal policy optimization model.

4. The method of claim 1, wherein the set of metrics include at least one of a number of computing instances within the computing environment, a processor utilization of computing instances within the computing environment, a memory utilization of computing instances within the computing environment a number of requests obtained by the queue-based service, a queue length associated with the queue-based service, a status of queue-based service, and a number of discard requests the queue-based service.

5. The method of claim 1, wherein the weighted accumulated reward value for the set of time steps includes a reward value determined based on at least one of a number of processed requests, a number of computing instances within the computing environment, a number is discarded requests, a queue service unavailable penalty, a inaction reward, and a queue size penalty.

6. The method of claim 1, wherein the set of metrics obtained from the computing environment supporting the queue-based service is simulated by a third machine learning model.

7. The method of claim 1, wherein updating the set of parameters of the first machine learning model is preformed within a test environment distinct from the computing environment.

8. A non-transitory computer-readable medium storing executable instructions embodied thereon, which, when executed by a processing device, cause the processing device to perform operations comprising:
obtaining a first input indicating a first state of a computing environment including a set of computing instances executing a service;
causing a policy machine learning model to generate a scaling decision associated with the set of computing instances based on the first input;
obtaining a second input indicating a second state of the computing environment including the set of computing instances executing the service as a result of implementing the scaling decision;
causing a value machine learning model to generate a first value indicating a performance of the policy machine learning model based on the second state of the computing environment;
determining a reward value based on the second state of the computing environment; and
causing a set of parameters of the policy machine learning model to be updated based on a result of performing backpropagation using the first value and the reward value.

9. The medium of claim 8, wherein the scaling decision includes at least one of: increasing a number of computing instances of the set of computing instances, decreasing a number of computing instances the set of computing instances, modifying a configuration of a subset of computing instances of the set of computing instances, and modifying a network configuration associated with the subset of computing instances of the set of computing instances.

10. The medium of claim 8, wherein determining the reward value further comprises determine an accumulated reward values based on a previous reward value determined based on a previous state of the computing environment and a previous scaling decision.

11. The medium of claim 10, wherein a weight value is applied to the previous reward value thereby causing the previous reward value to be reduced relative to an interval of time that has expired since the previous reward value was determined.

12. The medium of claim 8, wherein the processing device further performs operations comprising:
obtaining a third input indicating a third state of the computing environment; and
causing the policy machine learning model to generate a second scaling decision based on the third input without causing the value machine learning model to generate an output.

13. The medium of claim 8, wherein backpropagation is performed through a policy gradient.

14. The medium of claim 8, wherein the computing environment is simulated.

15. The medium of claim 8, wherein determining the reward value further comprises computing the reward value as a function of a number of processed requests, a number of pending requests in a queue associated with the service, a first penalty associated with the service being unavailable, and a second penalty associated with the number of pending requests in the queue associated with the service.

16. A system comprising:
a memory component; and
a processing device coupled to the memory component, the processing device to perform operations comprising:
determining, by a first machine learning model, a scaling operation based on a first state of a computing environment executing a service;
causing the scaling operation to be performed on the computing environment;
determining, by a second machine learning model, an estimated value associated with a second state of the computing environment after the scaling operation is performed; and
causing the first machine learning model to adjust a set of parameters of the first machine learning model to maximize an advantage value determined based on the estimated value and a reward value determined based on the second state of the computing environment.

17. The system of claim 16, wherein causing the first machine learning model to adjust the set of parameters further comprises performing backpropagation through a policy gradient using the advantage value.

18. The system of claim 16, wherein the reward value further comprises an accumulated weight value determined based at least in part on a set of metrics obtained from the computing environment over an interval of time.

19. The system of claim 16, wherein the scaling operation includes at least one of: increasing a number of computing instances, decreasing a number of computing instances, and modifying a configuration of a computing instance, modifying a network configuration associated with the computing environment.

20. The system of claim 16, wherein causing the first machine learning model to determine the scaling operation further comprises causing the first machine learning model to determine a first value to increase computing capacity of the computing environment and a second value to decrease computing capacity of the computing environment.
